(19) United States
(12) Patent Application Publication
(10) Pub. No.: US 2015/0145329 A1
(43) Pub. Date: May 28, 2015

(54) POWER SUPPLY CONTROLLING CIRCUIT AND STORAGE APPARATUS

(71) Applicant: FUJITSU LIMITED, Kawasaki-shi (JP)

(72) Inventors: Ikki Okashita, Kawasaki (JP); Kiyotaka Tomihari, Kawasaki (JP)

(73) Assignee: FUJITSU LIMITED, Kawasaki-shi (JP)

(21) Appl. No.: 14/514,517

(22) Filed: Oct. 15, 2014

(30) Foreign Application Priority Data
Nov. 28, 2013 (JP) 2013-246829

(51) Int. Cl. H02J 9/06

(52) U.S. Cl. CPC H02J 9/061
USPC 307/23

(57) ABSTRACT

A power supply controlling circuit, includes: at least one switch configured to switch between on and off of a power supply to at least one apparatus; at least one switch controlling circuit configured to control on/off of the switch; at least one monitoring circuit configured to monitor whether or not the switch controlling circuit is operating properly; and a backup circuit configured to accumulate electric power and to control on/off of the switch by using the accumulated electric power, in a case in which the monitoring circuit determines that the switch controlling circuit is not operating properly.

### CROSS-REFERENCE TO RELATED APPLICATION

This application is based upon and claims the benefit of priority of the prior Japanese Patent Application No. 2013-246829, filed on Nov. 28, 2013, the entire contents of which are incorporated herein by reference.

### FIELD

The embodiments discussed herein are related to power supply controlling circuits and storage apparatuses.

### BACKGROUND

In storage apparatuses, hot swap ICs are used to control the ON/OFF of the power supply to a hard disk drive (HDD). FIG. 13 illustrates an example in which a hot swap IC is used to control the ON/OFF of the power supply to an HDD.

As illustrated in FIG. 13, an HDD 23 is connected to the power supply through a field-effect transistor (FET) 4. The gate terminal of the FET 4 is connected to an output terminal of a hot swap IC 1, and upon receiving an HDD Enable signal, the hot swap IC 1 turns on the power supply to the HDD 23 by applying a voltage to the gate terminal of the FET 4.

As an existing technique related to power supply apparatuses, there is a power supply apparatus that includes a capacitor configured, when a failure occurs in the power supply, to supply accumulated electric power to a load that operates at an initial stage after the failure occurs and a secondary battery configured to supply accumulated electric power to a load that operates continuously.

There is also an image forming apparatus that includes a first supplying unit configured to supply electric power to a load and a second supplying unit chargeable by the first supplying unit and configured to supply electric power to the load. In such an image forming apparatus, upon a failure occurs in the second supplying unit, the first supplying unit is controlled to supply electric power to the load without charging the second supplying unit.

Japanese Laid-open Patent Publication No. 2006-81330 and Japanese Laid-open Patent Publication No. 2009-298081 are examples of related art.

In FIG. 13, however, occurrence of a failure in the hot swap IC 1 leads to a problem in that the ON/OFF of the power supply to the HDD 23 is unable to be controlled. In addition, the hot swap IC 1 is mounted on a backplane to which the HDD 23, a power supply module, and so on are connected, and the backplane is not hot-pluggable. Thus, when the hot swap IC 1 is to be replaced, the storage apparatus has be to be stopped.

### SUMMARY

According to an aspect of the invention, a power supply controlling circuit, includes: at least one switch configured to switch between on and off of a power supply to at least one apparatus; at least one switch controlling circuit configured to control on/off of the switch; at least one monitoring circuit configured to monitor whether or not the switch controlling circuit is operating properly; and a backup circuit configured to accumulate electric power and to control on/off of the switch by using the accumulated electric power, in a case in which the monitoring circuit determines that the switch controlling circuit is not operating properly.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates a configuration of a RAID apparatus according to an embodiment;

FIG. 2 illustrates a hardware unit configuration of a CE;

FIG. 3 illustrates an example of primary functions provided by a backplane;

FIG. 4 illustrates IC devices mounted on the backplane;

FIG. 5 illustrates a configuration of a power supply controlling circuit according to an embodiment;

FIG. 6 illustrates a configuration of a gate voltage monitoring circuit;

FIG. 7 illustrates an existing hot swap circuit;

FIG. 8 illustrates a configuration of a backup circuit;

FIG. 9 is an illustration for describing an operation of the backup circuit under normal conditions;

FIG. 10 is an illustration for describing an operation of the backup circuit when a failure has occurred in a hot swap IC;

FIG. 11 illustrates an existing hot swap circuit employed when the power supply to a plurality of HDDs is to be controlled;

FIG. 12 illustrates a hot swap circuit according to an embodiment employed when the power supply to a plurality of HDDs is to be controlled; and

FIG. 13 illustrates an example in which a hot swap IC is used to control the ON/OFF of the power supply to an HDD.

### DESCRIPTION OF EMBODIMENTS

Hereinafter, embodiments of a power supply controlling circuit and a storage apparatus disclosed in the present application will be described in detail with reference to the drawings. It is to be noted that the embodiments do not limit the technique of the disclosure.

### Embodiments

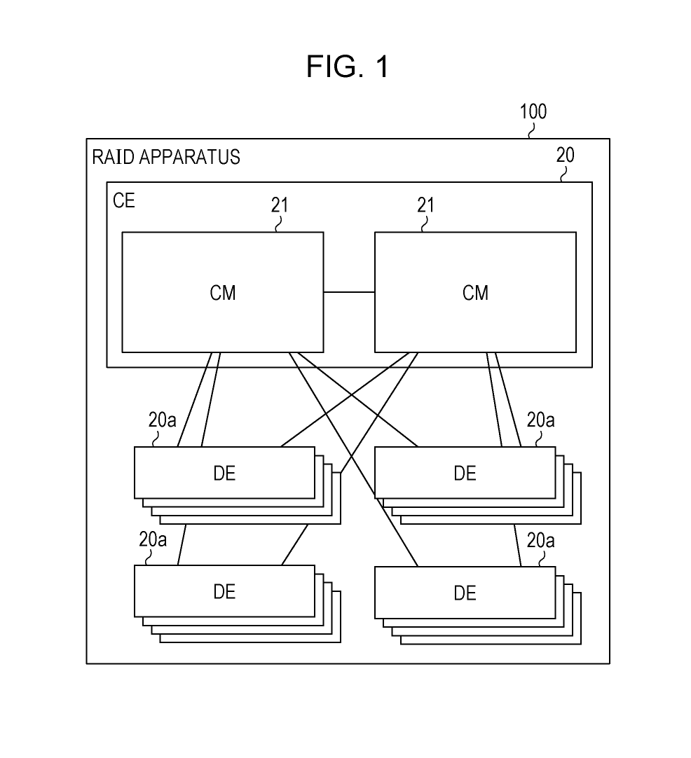

First, a redundant arrays of inexpensive disks (RAID) apparatus according to an embodiment will be described. FIG. 1 illustrates a configuration of a RAID apparatus according to an embodiment. As illustrated in FIG. 1, a RAID apparatus 100 is a storage apparatus that includes a controller enclosure (CE) 20 and 16 device enclosures (DEs) 20a.

The CE 20 is a device that includes controller modules (CMs) 21 for controlling the RAID apparatus 100 and a plurality of HDDs. The CE 20 includes the two CMs 21. The DE 20a is a device that includes a plurality of HDDs. Although 16 DEs 20a are illustrated in FIG. 1, the RAID apparatus 100 may include any desired number of DEs 20a.

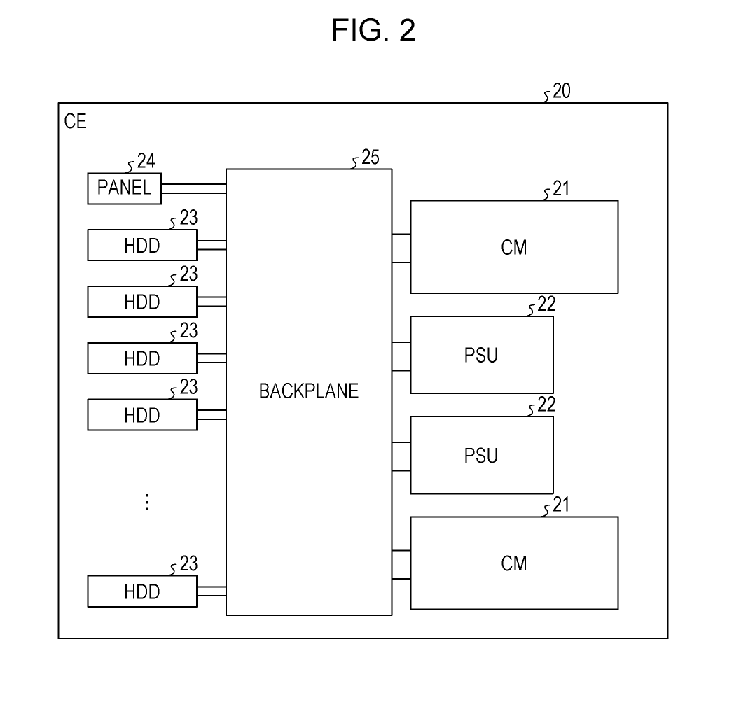

FIG. 2 illustrates a hardware unit configuration of the CE 20. As illustrated in FIG. 2, the CE 20 includes such units as the two CMs 21, two power supply units (PSUs) 22, a plurality of HDDs 23, and a panel 24.

The PSUs 22 are each a power supply module for supplying power to the CE 20. The CMs 21 and the PSUs 22 are duplexed. The HDDs 23 are each a disk device for storing data. The panel 24 is a display device for displaying the status of the CE 20.

In FIG. 2, the hardware unit configuration of the DEs 20a is such that the two CMs 21 are replaced with respective expanders (EXPs). Here, the EXPs are interfaces for connecting other DEs 20a.

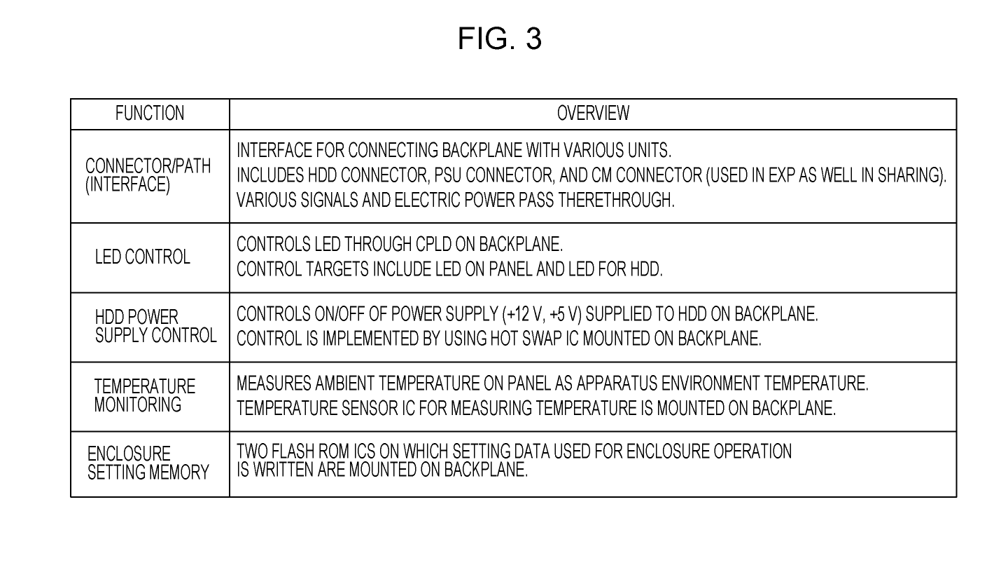

The CE 20 includes a backplane 25, which is hardware serving as a core for connecting and relaying various signals among the units. FIG. 3 illustrates an example of primary functions provided by the backplane 25. As illustrated in FIG. 3, the functions provided by the backplane 25 include a connector and path, light-emitting diode (LED) control, power supply control of the HDDs 23, temperature monitoring, and an enclosure setting memory.

The connector and path serves as an interface for connecting the backplane 25 and the various units. The connector includes an HDD connector, a PSU connector, and a CM connector (used in the EXP as well in sharing). Various signals and electric power pass through the connector and path.

The LED control is carried out through a complex programmable logic device (CPLD) on the backplane 25. Targets of the LED control include an LED on the panel 24 and LEDs for the HDDs 23.

As the power supply control of the HDDs 23, the ON/OFF of the power supply (+12 V, +5 V) to be supplied to the HDDs 23 is controlled through the hot swap IC 1 mounted on the backplane 25.

In the temperature monitoring, the temperatures of the intake air and the exhaust air of the apparatus are monitored. In order to monitor the temperatures, the backplane 25 is provided with a temperature sensor IC. While an ambient temperature on the panel 24 is measured as an environmental temperature of the apparatus, the main body of the temperature sensor is mounted on the backplane 25.

The enclosure setting memory is a flash read only memory (ROM) IC on which setting data to be used in an enclosure operation is written. The backplane 25 is provided with two flash ROM ICs.

Of these functions, for the power supply control of the HDDs 23, IC devices and a number of circuit components for realizing the stated function are mounted on the backplane 25, and the circuit becomes complex as a result. In particular, the hot swap IC 1, which is a power supply controlling circuit for the HDD 23, has to be provided in a number corresponding to the number of HDDs 23 to be mounted, and thus the rate of failures relatively becomes higher in the RAID apparatus 100 provided with a number of HDDs 23.

Therefore, such a failure occurs that the HDDs 23 are not recognized even when the power supply of the RAID apparatus 100 is turned on in a mass production shipping test or in the field due to the failure in the hot swap IC 1.

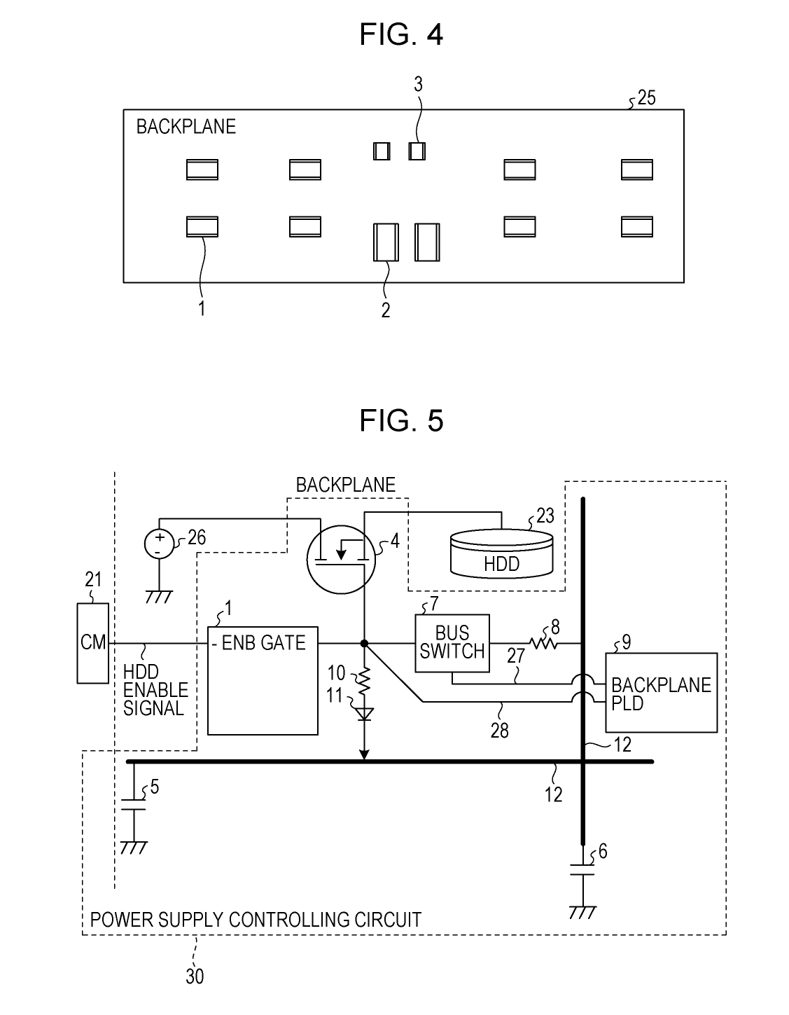

FIG. 4 illustrates IC devices mounted on the backplane 25. In the example illustrated in FIG. 4, eight hot swap ICs 1, two temperature sensor ICs 2, and two flash ROM ICs 3 are mounted on the backplane 25.

A configuration of a power supply controlling circuit according to an embodiment will now be described. FIG. 5 illustrates a configuration of a power supply controlling circuit according to an embodiment. As illustrated in FIG. 5, a power supply controlling circuit 30 is mounted on the backplane 25 and includes the hot swap IC 1, the FET 4, a Cp 5, a Cq 6, a bus switch 7, an Rg 8, a backplane PLD 9, an Rd 10, a Dd 11, and an electric power supplying path 12. It is to be noted that the illustration of the circuit elements other than the hot swap IC 1 is omitted in FIG. 4.

The hot swap IC 1 is an IC that controls the operation of the FET 4 by applying or not applying a voltage to the gate terminal of the FET 4. Upon receiving an HDD Enable signal from the CM 21, the hot swap IC 1 applies a voltage to the gate terminal of the FET 4 so as to turn on the FET 4. In addition, the hot swap IC 1 alleviates circuit stress caused by an inrush current generated when the power supply to the HDD 23 is turned on. Furthermore, the hot swap IC 1 suppresses an overcurrent generated at the time of short-circuiting at an HDD 23 side.

The FET 4 operates as a switch between a direct current (DC) power supply 26 and the HDD 23. Upon the hot swap IC 1 applying a voltage to the gate terminal of the FET 4, the power supply to the HDD 23 is turned on, and when the hot swap IC 1 stops applying a voltage to the gate terminal of the FET 4, the power supply to the HDD 23 is turned off.

The Cp 5 and the Cq 6 are capacitors that accumulate electric power to be supplied to the gate of the FET 4 when a failure occurs in the hot swap IC 1. The Cp 5 and the Cq 6 are charged while the hot swap IC 1 is operating properly.

The bus switch 7 is connected to a path that connects the output terminal of the hot swap IC 1 and the gate terminal of the FET 4 and to the Cp 5 and the Cq 6 through the Rg 8 and the electric power supplying path 12. The bus switch 7 switches between charging and discharging of the Cp 5 and the Cq 6 in tandem with an ON/OFF instruction of the HDD 23 issued from the CM 21 to the hot swap IC 1.

The Rg 8 is a resistor that is connected to the bus switch 7 and to the electric power supplying path 12. The Rg 8 receives electric power from the Cp 5 and the Cq 6 when the bus switch 7 is ON so as to suppress an inrush current.

The backplane PLD 9 controls the ICs and so forth mounted on the backplane 25. The backplane PLD 9 is connected to the path that connects the output terminal of the hot swap IC 1 and the gate terminal of the FET 4 and to the bus switch 7.

The backplane PLD 9 monitors the output of the hot swap IC 1 and determines that a failure has occurred in the hot swap IC 1 in a case in which the hot swap IC 1 is not outputting a gate voltage to the FET 4 even though the CM 21 has issued an instruction that the power supply to the HDD 23 is to be turned on. When the backplane PLD 9 determines that a failure has occurred in the hot swap IC 1, the backplane PLD 9 turns ON the bus switch 7.

In other words, the backplane PLD 9, a path 27, and a path 28 collectively function as a gate voltage monitoring circuit. Here, the path 27 is a path that connects the bus switch 7 and the backplane PLD 9. Meanwhile, the path 28 is a path that connects the backplane PLD 9 and the path that connects the output terminal of the hot swap IC 1 and the gate terminal of the FET 4.

The Rd 10 is connected to the path that connects the output terminal of the hot swap IC 1 and the gate terminal of the FET 4 and to the Cp 5 and the Cq 6 through the Dd 11. The Rd 10 is a resistor for feeding the gate voltage outputted from the hot swap IC 1 to the Cp 5 and the Cq 6 while the hot swap IC 1 is operating properly.

The Dd 11 is a diode that is disposed between the Rd 10 and the electric power supplying path 12 and that suppresses a countercurrent from the Cp 5 and the Cq 6 to the hot swap IC 1 when a failure occurs in the hot swap IC 1.

The electric power supplying path 12 is a path that connects the Cp 5, the Cq 6, the Rg 8, and the Dd 11. The electric power supplying path 12 is used to charge the Cp 5 and the Cq 6 while the hot swap IC 1 is operating properly and is used to discharge the Cp 5 and the Cq 6 when a failure has occurred in the hot swap IC 1. The electric power supplying path 12 itself is charged while the Cp 5 and the Cq 6 are charged and is discharged while the Cp 5 and the Cq 6 are discharged.

The Cp 5, the Cq 6, the electric power supplying path 12, the Rd 10, and the Dd 11 collectively function as a supplying circuit that supplies electric power to the gate of the FET 4 when a failure has occurred in the hot swap IC 1. Meanwhile, the bus switch 7, the Rg 8, and the path 28 collectively function as an alternative circuit that serves as an alternative of the hot swap IC 1 when a failure has occurred in the hot swap IC 1. In addition, a circuit formed by the supplying circuit and the alternative circuit functions as a backup circuit that backs up the hot swap IC 1.

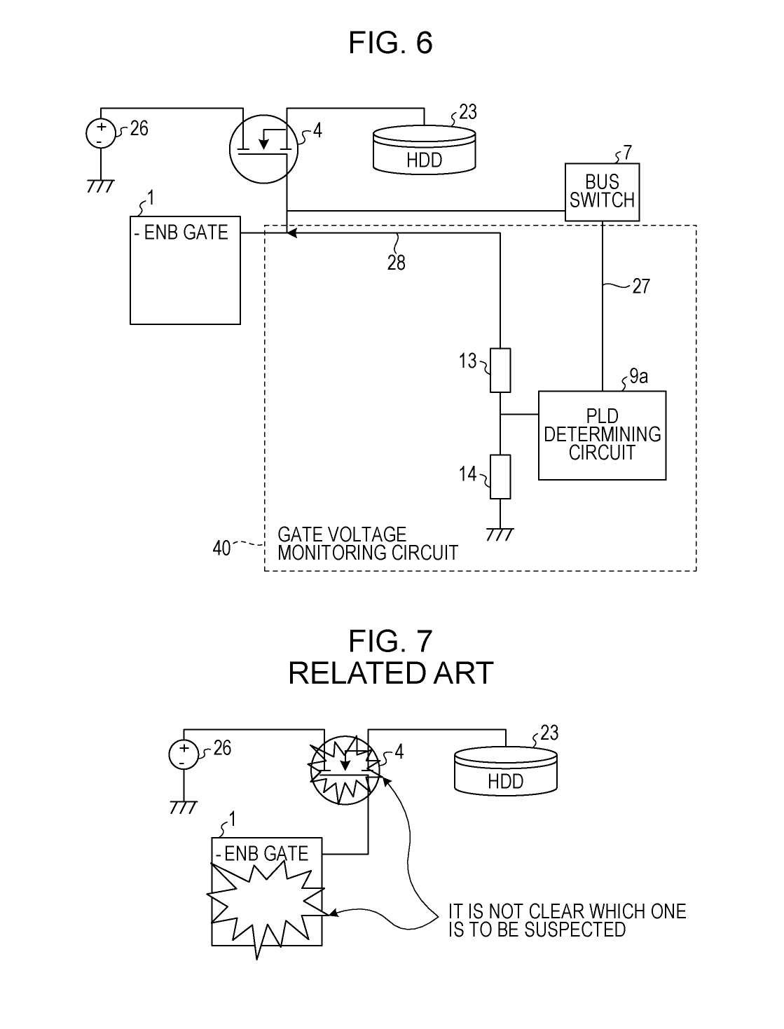

A configuration of a gate voltage monitoring circuit will now be described. FIG. 6 illustrates a configuration of a gate voltage monitoring circuit. As illustrated in FIG. 6, a gate voltage monitoring circuit 40 includes a PLD determining circuit 9a and voltage dividing resistors 13 and 14. It is to be noted that the voltage dividing resistors 13 and 14 are omitted in FIG. 5. The PLD determining circuit 9a is a circuit that illustrates part of the functions provided by the backplane PLD 9.

The PLD determining circuit 9a divides the gate voltage of the FET 4 by using the voltage dividing resistors 13 and 14 so as to monitor the gate voltage, and determines that a failure has occurred in the hot swap IC 1 if the gate voltage reaches or falls below a threshold value. When the PLD determining circuit 9a determines that a failure has occurred in the hot swap IC 1, the PLD determining circuit 9a notifies the CM 21 of the failure and also turns ON the bus switch 7 of the alternative circuit. Thereafter, when the HDD 23 is removed from the RAID apparatus 100, the PLD determining circuit 9a turns OFF the bus switch 7 of the alternative circuit.

As the gate voltage monitoring circuit 40 monitors the gate voltage of the FET 4, when such a failure that power is not supplied to the HDD 23 occurs, the RAID apparatus 100 can determine whether the failure has occurred in the hot swap IC 1 or in the FET 4.

FIG. 7 illustrates an existing hot swap circuit. As illustrated in FIG. 7, with the existing hot swap circuit, when such a failure that power is not supplied to the HDD 23 occurs, the RAID apparatus 100 is unable to determine whether the hot swap IC 1 or the FET 4 is to be suspected of the failure.

It is to be noted that failures to occur in the hot swap IC 1 include the following. The gate voltage outputted from the hot swap IC 1 falls midway. The gate voltage outputted from the hot swap IC 1 does not rise to a prescribed value. The gate voltage is not outputted from the hot swap IC 1. The gate voltage outputted from the hot swap IC 1 falls.

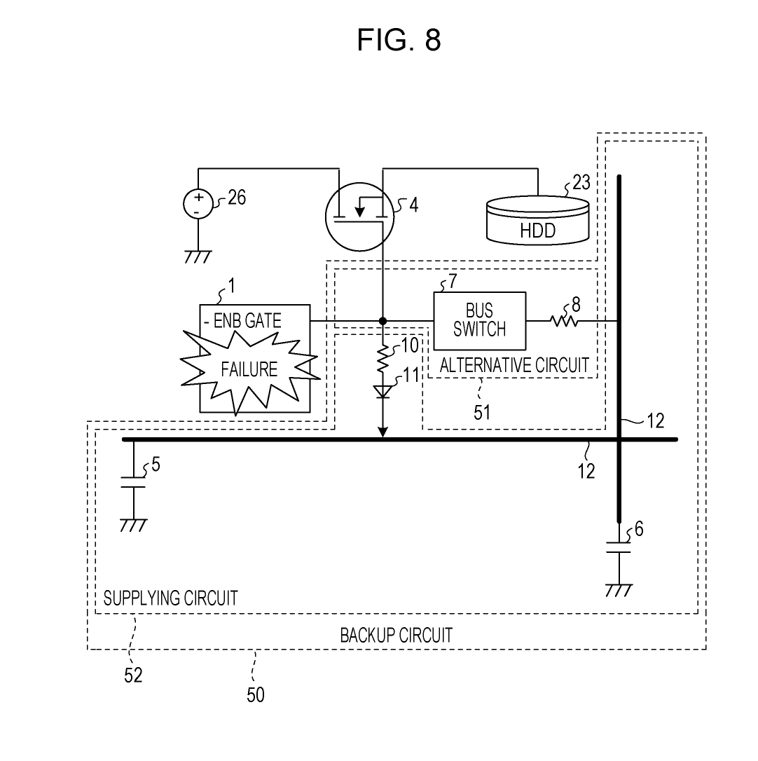

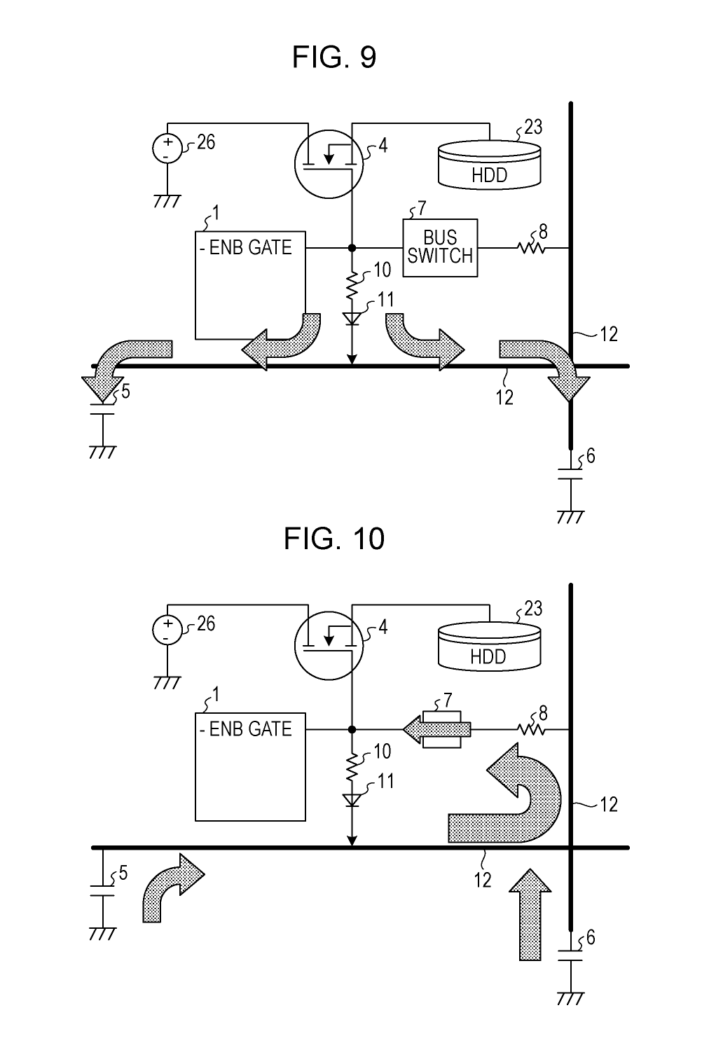

The operation of the backup circuit will now be described with reference to FIG. 8 to FIG. 10. FIG. 8 illustrates the configuration of the backup circuit; FIG. 9 is an illustration for describing the operation of the backup circuit under normal conditions; and FIG. 10 is an illustration for describing the operation of the backup circuit when a failure has occurred in the hot swap IC 1.

As illustrated in FIG. 8, a backup circuit 50 includes an alternative circuit 51 and a supplying circuit 52. The alternative circuit 51 includes the bus switch 7 and the Rg 8. The supplying circuit 52 includes the Cp 5, the Cq 6, the Rd 10, the Dd 11, and the electric power supplying path 12.

While the hot swap IC 1 is operating properly, as illustrated in FIG. 9, the backup circuit 50 accumulates electric power in the capacitors, namely, the Cp 5 and the Cq 6 with the gate voltage of the hot swap IC 1 supplied through the Rd 10. It is to be noted that part of the electric power is accumulated in the electric power supplying path 12 as well.

Meanwhile, when a failure occurs in the hot swap IC 1, as illustrated in FIG. 10, the bus switch 7 is tuned ON, and the electric power accumulated in the Cp 5, the Cq 6, and the electric power supplying path 12 is discharged. Thus, a voltage is applied to the gate terminal of the FET 4.

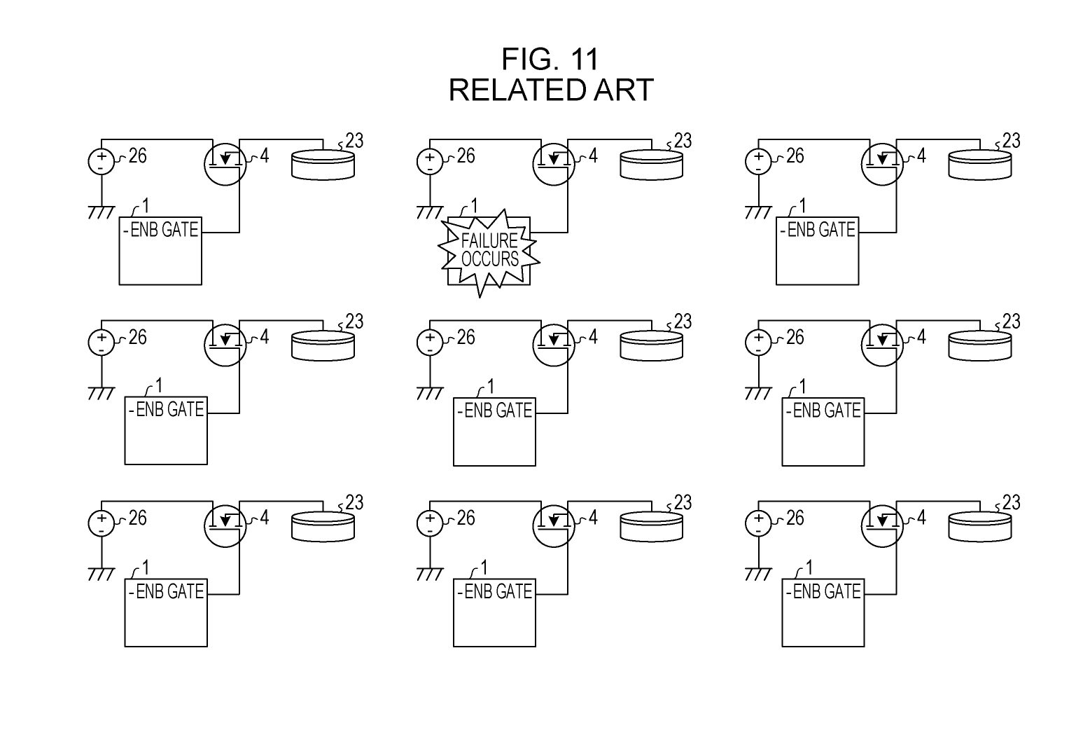

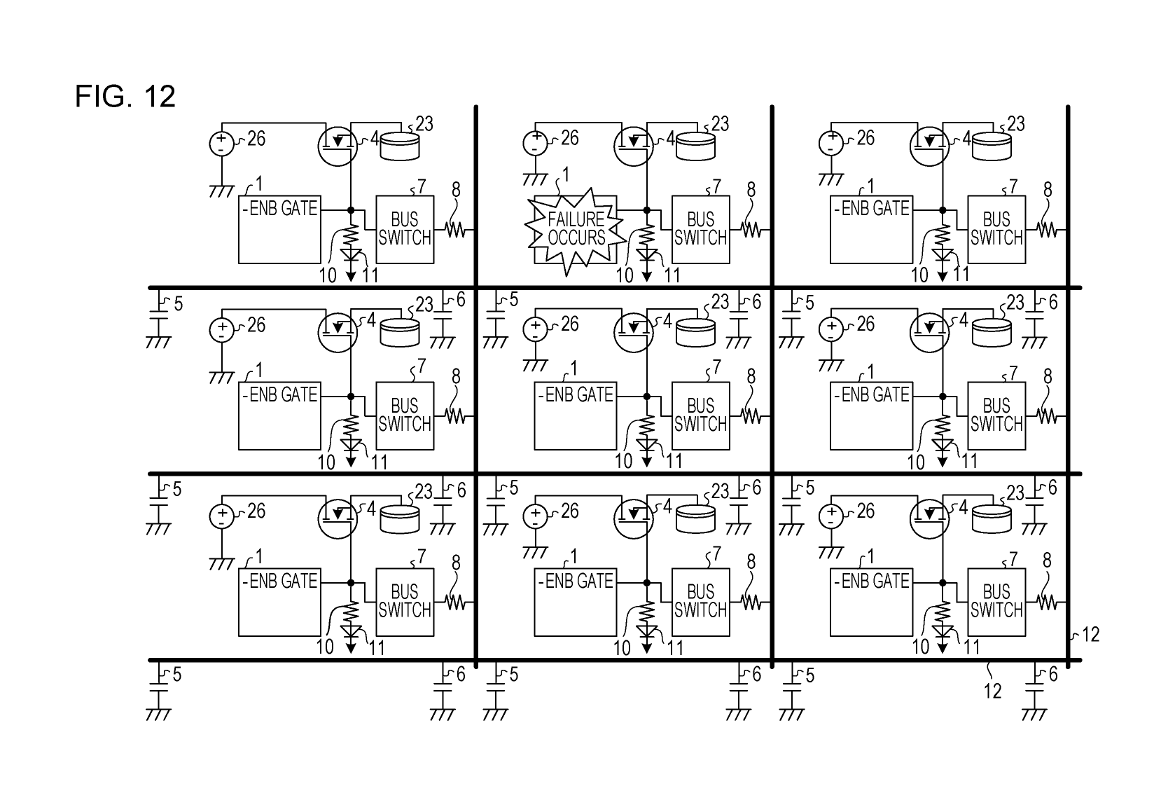

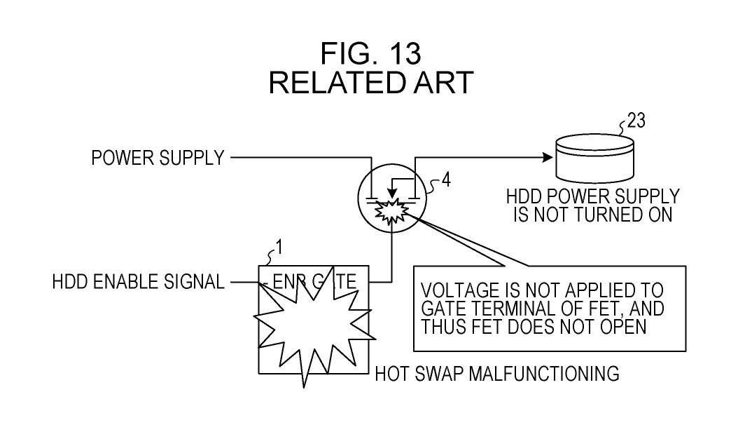

Subsequently, a hot swap circuit that controls the power supply to the plurality of HDDs 23 will be described with reference to FIG. 11 and FIG. 12. FIG. 11 illustrates an existing hot swap circuit employed when the power supply to the plurality of HDDs 23 is to be controlled, and FIG. 12 illustrates a hot swap circuit according to an embodiment employed when the power supply to the plurality of HDDs 23 is to be controlled.

As illustrated in FIG. 11, the hot swap ICs 1 are provided for the respective HDDs 23 in the existing hot swap circuit, and when a failure occurs in any one of the hot swap ICs 1, power stops being supplied to the HDD 23 of which the power supply is controlled by the hot swap IC 1 in which the failure has occurred.

Meanwhile, as illustrated in FIG. 12, while, as in the existing hot swap circuit, the hot swap ICs 1 are provided for the respective HDDs 23 in the hot swap circuit according to the embodiment, the Cps 5, the Cqs 6, and the electric power supplying paths 12, which are each provided in the number identical to the number of the HDDs 23, are shared by the HDDs 23.

If a failure occurs in any one of the hot swap ICs 1, the gate voltage monitoring circuit 40 that monitors the gate output of the hot swap IC 1 in which the failure has occurred detects the failure and turns ON the corresponding bus switch 7.

In response, not only the Cp 5, the Cq 6, and the electric power supplying path 12 located in the vicinity of the aforementioned hot swap IC 1 but also the other Cps 5, Cqs 6, and electric power supplying paths 12 supply electric power to the gate of the FET 4 connected to the hot swap IC 1 in which the failure has occurred.

In addition, the Cps 5, the Cqs 6, and the electric power supplying paths 12 are charged by the other hot swap ICs 1. Therefore, the hot swap circuit according to the embodiment can continuously supply electric power to the gate of the FET 4 connected to the hot swap IC 1 in which a failure has occurred.

As described thus far, according to the embodiments, the backup circuit 50 accumulates electric power while the hot swap IC 1 is operating properly, and the gate voltage monitoring circuit 40 monitors the gate voltage of the FET 4. The gate voltage monitoring circuit 40 then determines whether the hot swap IC 1 is operating properly or a failure has occurred in the hot swap IC 1. When the gate voltage monitoring circuit 40 determines that a failure has occurred in the hot swap IC 1, the backup circuit 50 operates so as to maintain the gate voltage of the FET 4. Therefore, even if a failure occurs in the hot swap IC 1, the ON/OFF of the FET 4 can be controlled so as to control the power supply to the HDD 23.

In addition, according to the embodiments, when the plurality of hot swap ICs 1 corresponding to the respective HDDs 23 control the power supply to the HDDs 23, even if a failure occurs in one of the hot swap ICs 1, the backup circuit 50 is charged by the other hot swap ICs 1. Therefore, the backup circuit 50 can continuously supply electric power to the gate of the FET 4 connected to the hot swap IC 1 in which a failure has occurred.

Although duplexing the hot swap ICs 1 can be considered, the backplane 25 does not have much space for mounting circuits, and it is not possible to add a large component or circuit to the backplane 25. Therefore, such a measure as duplexing the hot swap ICs 1 is not able to be employed due to an issue of mounting space. In addition, the hot swap ICs 1 are to be provided in the number corresponding to the number of HDDs 23 mounted on the CE 20 and the DE 20a, and the cost therefor being considered, it is not possible to employ such a measure as duplexing the hot swap ICs 1.

In addition, although a case in which the power supply to the HDD is turned on and off has been described in the embodiments, the embodiments are not limited to such a case and can be applied, in a similar manner, to a case in which the power supply to any desired apparatus is turned on and off.

In addition, although a case in which the power supply to the HDD is turned on and off by using the FET has been described in the embodiments, the embodiments are not limited to such a case and can be applied, in a similar manner, to a case in which the power supply to the HDD is turned on and off by using another element or the like provided with a switching function.

In addition, although a case in which the FET is switched on and off by using the hot swap IC has been described in the embodiments, the embodiments are not limited to such a case and can be applied, in a similar manner, to a case in which the FET is switched on and off by using another IC.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A power supply controlling circuit, comprising:
at least one switch configured to switch between on and off of a power supply to at least one apparatus;
at least one switch controlling circuit configured to control on/off of the switch;
at least one monitoring circuit configured to monitor whether or not the switch controlling circuit is operating properly; and
a backup circuit configured to accumulate electric power and to control on/off of the switch by using the accumulated electric power, in a case in which the monitoring circuit determines that the switch controlling circuit is not operating properly.

2. The power supply controlling circuit according to claim 1,
wherein the backup circuit accumulates electric power, in a case in which the monitoring circuit determines that the switch controlling circuit is operating properly.

3. The power supply controlling circuit according to claim 1,
wherein
the at least one apparatus includes a plurality of apparatuses,
the at least one switch includes a plurality of switches corresponding to the respective apparatuses,
the at least one switch controlling circuit includes a plurality of switch controlling circuits, and
the at least one monitoring circuit includes a plurality of monitoring circuits, and
wherein the backup circuit controls on/off of a switch corresponding to a switch controlling circuit that has failed, while accumulating electric power supplied from switch controlling circuits other than the switch controlling circuit that has failed.

4. The power supply controlling circuit according to claim 1,
wherein the backup circuit includes
an alternative circuit configured to control on/off of the switch, in place of the switch controlling circuit, and
a supplying circuit configured to accumulate electric power and to supply the electric power to the alternative circuit, in a case in which the monitoring circuit determines that the switch controlling circuit is not operating properly.

5. The power supply controlling circuit according to claim 4,
wherein the alternative circuit includes
a bus switch configured to switch between on and off of the switch, and
a resistor configured to suppress an inrush current generated when the power supply to the apparatus is turned on by the switch.

6. The power supply controlling circuit according to claim 4,
wherein the supplying circuit includes
a capacitor configured to accumulate electric power, and
an electric power supplying path configured to supply the electric power from the capacitor to the alternative circuit and to accumulate the electric power.

7. A storage apparatus, comprising
a storage device;
a power supply of the storage device; and
a power supply controlling circuit configured to control the power supply,
wherein the power supply controlling circuit includes
a switch configured to switch between on and off of the power supply to the storage device,
a switch controlling circuit configured to control on/off of the switch,
a monitoring circuit configured to monitor whether or not the switch controlling circuit is operating properly, and
a backup circuit configured to accumulate electric power and to control on/off of the switch by using the accumulated electric power, in a case in which the monitoring circuit determines that the switch controlling circuit is not operating properly.
